(19) United States
(12) Patent Application Publication
(10) Pub. No.: US 2015/0010690 A1
(43) Pub. Date: Jan. 8, 2015

(54) METHOD FOR THE PREPARATION OF OIL-CONTAINING MEAT-BASED PRODUCTS COMPRISING A DIRECT OIL ADDITION PROTOCOL

(71) Applicant: CRETA FARM SOCIETE ANONYME INDUSTRIAL AND COMMERCIAL trading as CRETA FARM S.A., Rethymnon (GR)

(72) Inventors: Emmanouil Domazakis, Rethymnon (GR); Konstantinos Domazakis, Rethymnon (GR)

(21) Appl. No.: 14/376,927

(22) PCT Filed: Feb. 8, 2013
(86) PCT No.: PCT/EP2013/000391

§ 371 Date: Aug. 6, 2014

(30) Foreign Application Priority Data
Feb. 8, 2012 (GR) 20120100082
Mar. 5, 2012 (EP) 12158091.4

(51) Int. Cl. A23L 1/314; A23L 1/317

(52) U.S. Cl. CPC A23L 1/31454; A23L 1/3177; A23L 1/3175; A23V 2002/00
USPC 426/646; 426/641

(57) ABSTRACT

The present invention relates to oil-containing meat-based products, preferably products made of finely or/and coarsely comminuted meat or minced meat, which exhibit exceptional stability. Moreover, the present invention pertains to a process for preparing said oil-containing meat-based products, comprising a simultaneous addition of oil and aqueous medium to a meat preparation, preferably in a multi-step mode. The invention further relates to meat-based products, obtainable by that process.

The present invention relates to oil-containing meat-based products, preferably products made of finely or/and coarsely comminuted meat or minced meat, which exhibit exceptional stability. Moreover, the present invention pertains to a process for preparing said oil-containing meat-based products, comprising a simultaneous addition of oil and aqueous medium to a meat preparation, preferably in a multi-step mode.

Concerns have been expressed that a high intake of saturated fats might have adverse effects on health risks. For this reason, the recent views on dietary issues focus on the concept of replacing the animal fats, with vegetable oils rich in unsaturated fatty acids, whenever possible.

Meat-based products containing vegetable oil are known and they can essentially be prepared by two different methods of incorporating the oil, namely the direct incorporation, i.e. by direct admixing the oil into the meat preparation during the production of the latter, and the indirect incorporation, i.e. by pre-emulsifying the oil before addition to the meat preparation or by using a carrier medium. Examples of direct admixture of oil into meat-based preparations have been demonstrated by EP 1361804 and EP 2263482. EP 1361804 describes a process for the preparation of olive oil-containing emulsion-type products made of finely comminuted meat, which includes a single step of adding olive oil, after the finely comminuted meat has been mixed with water, salt, polyphosphoric salts, vegetable proteins, milk proteins and starch. EP 2263482, on the other hand, deals with the provision of a novel methodology for preparing oil-containing meat-based products, which allows the use of a reduced amount of additives selected from emulsifying agents, stabilizing agents and/or thickening agents. The object of the latter invention was solved by the multi-step addition of oil.

The object of the present invention is to enable stability in a meat emulsion-based system, comprising oil in the maximum technologically feasible quantity, as permitted by a direct oil addition method, which may be related with absence of added emulsifiers and gelling agents. This aim is accomplished by the use of a direct oil addition protocol, that comprises the simultaneous addition of oil and an aqueous medium into a meat preparation. According to the herein disclosed method, a quantity of oil is added simultaneously, with a quantity of an aqueous medium in a meat preparation. The simultaneous admixture of the liquid oil and an aqueous medium in a meat preparation, as an oil addition protocol, constitutes a novel approach for achieving maximum stability of oil incorporation. The invention, thus relates to a process for preparing meat-based products, wherein the process comprises a simultaneous addition of oil and aqueous medium in the meat preparation. Preferably, this process takes place in a multi-step mode, more preferably in a two-step mode. The invention further relates to meat-based products, obtainable by that process. Preferred embodiments of the invention are described in the description hereinafter and the claims.

In the context of the present invention, the term “meat-based products”, whenever used herein, comprises products made of finely comminuted meat, for example cooked sausages (such as frankfurter-type sausages, parizers, mortadella-type, etc), products based on coarsely comminuted meat, for example raw sausages (such as country fresh sausages, breakfast-type sausages, etc), products based on minced-meat (such as burgers, meat balls, doner kebab, etc) or other products (such as spreadable meat-based products, etc).

The term “oil”, whenever used herein, comprises any edible oil fit for human consumption. Preferably, from a dietary point of view, the oil used according to the invention, is an edible vegetable oil, or a mixture thereof. Edible oils that can be used according to the present invention, without being restricted thereto, include: olive oil, palm oil, soybean oil, canola oil, pumpkin seed oil, corn oil, rape oil, sunflower oil, safflower oil, peanut oil, walnut oil, wheat germ oil, grape seed oil, sesame oil, argan oil, rice bran oil, and mixtures thereof. Many other kinds of oils that are used for cooking can, however, also be used, such as almond oil and avocado oil. The oils used according to the present invention are preferably liquid at a temperature between 0-25° C. and more preferably liquid between 0-15° C., due to their high unsaturated fatty acid content. The oils used according to the invention are not subjected to any treatment for modifying the initial distribution of fatty acids or the degree of their saturation, by processes like interesterification or hydrogenation. According to a preferred embodiment, the oil has not been pre-emulsified before the addition. From the oils mentioned above, olive oil, sunflower oil, corn oil, soybean oil, canola oil and mixtures thereof are especially preferred, with olive oil being the most preferred oil. Preferably, the oil of the present invention is a virgin olive oil, more preferably an extra virgin olive oil. Moreover, it is preferred that the oil of the present invention is an organic oil, i.e. oil produced according to organic farming standards, verified by accredited organisations. Preferably, the oil is used in substitution of animal fat, which is conventionally added during the preparation of meat-based products, either directly or via the use of muscular meat tissues of high fat content.

In the context of the present invention, the aqueous medium is water or aqueous solution or aqueous dispersion and it is preferably at a liquid state. The temperature of the water or aqueous solution/dispersion is preferably lower than 25° C., more preferably lower than 15° C. and most preferably lower than 5° C. Preferably, the water is icy water of a temperature between 0-2° C., prepared for example by adding ice to tap water. In that case, the water is mainly at a liquid state, in a percentage, preferably in the range of 65% (v/v), more preferably in the range of 75% (v/v) and most preferably in the range of 85% (v/v). In the case of an aqueous solution/dispersion, this may contain dissolved components, such as salts (e.g. NaCl), sugars, antioxidants or/and undissolved components, such as herbs, seasonings and vegetables. The aqueous solution/dispersion may also contain one or more non-functional proteins, e.g. proteins added mainly for organoleptic purposes or compositions containing thereof (e.g. hydrolysed proteins, spray-dried broth). Preferably, the aqueous medium does not contain an emulsifier. More preferably, the aqueous medium does not contain a gelling agent.

Even more preferably, neither an emulsifier nor a gelling agent is included in the composition of the aqueous medium. Further, the aqueous medium, does not preferably contain a stabiliser. Moreover, the aqueous medium does not preferably contain additives from the groups of preservatives (e.g. curing salts) or antimicrobial compounds.

According to the present invention, the oil addition protocol comprises the addition of oil with a quantity of an aqueous medium into the meat preparation, in a simultaneous mode. Preferably, the addition protocol comprises the multi-step addition of oil and aqueous medium, for example in 2-5 steps, preferably in 2-3 steps, most preferably in 2 steps. To realise the multi-step addition protocol, the amounts of oil and aqueous medium to be used for the preparation of the oil-containing meat-based products, are subdivided into different portions, having either the same or different sizes, which are added in the meat preparation in multiple steps during the production of the meat paste/meat mass. A portion of oil is then added simultaneously with a portion of aqueous medium. Thus, a single oil addition step starts with the simultaneous addition of an appropriate portion of the oil and aqueous medium to be added and ends when the whole amount of those portions of oil and aqueous medium are fully incorporated into the processed meat preparation, and a subsequent oil addition step does not start until the preceding oil addition step is finished. This multi-step addition of oil together with a quantity of aqueous medium enables a stable incorporation of the oil in the maximum technologically feasible quantity permitted via a direct admixture protocol. The superiority of the present method is particularly demonstrated in cases where processing aids, which could have a positive effect on the incorporation of the fat phase, are not used during the production of the meat paste/meat mass.

According to a preferred aspect of the invention, the process for the preparation of the meat-based product, involves a two step oil addition protocol, which comprises preparing a meat preparation by comminuting or mincing meat pieces, adding sodium chloride or mixtures of sodium chloride with substitutes thereof, and optionally adding at least one ingredient selected from antioxidants, stabilizers, emulsifiers, thickeners or gelling agents, processing aids, colouring agents, sugars, vegetables, microbial cultures, preservatives, flavor enhancers, acidifiers, seasonings, spices, nuts and mixtures thereof; adding a first portion of oil and simultaneously adding a portion of aqueous medium and mixing until the oil and aqueous medium have been incorporated, adding a second portion of oil and simultaneously adding a portion of aqueous medium and mixing until the oil and aqueous medium have been incorporated; and further processing to obtain the meat-based product.

Thus, according to an aspect of the invention, the method of direct oil incorporation underlined in the present invention, comprises the following steps:
1) Providing a meat preparation;
2) Providing oil;
3) Providing an aqueous medium;
4) Admixing (2) and quantity of (3) into (1), in a simultaneous mode;
5) Further processing to obtain a meat paste or meat mass;

Step (1) of the aforementioned procedure, provides a meat preparation prepared according to practices known in the art. The procedure under step (1) can include comminuting or mincing meat pieces and further processing, e.g. chopping and mixing. Step (1) is preferably carried out in a grinder or/and chopping and mixing apparatus, such as a bowl chopper (cutter). Preferably, the meat preparation of step (1) includes at least one auxiliary ingredient. According to the present invention, the term “auxiliary ingredients” includes salts, e.g. NaCl or mixtures of NaCl with substitutes thereof; preservatives, e.g. nitrite salts; stabilizers, e.g. phosphate salts; emulsifiers, e.g. milk proteins, plasma proteins, soy proteins, cereal proteins, pea protein, sesame protein, mono- and diglycerides of fatty acids; thickeners or gelling agents, e.g. starch, dietary fibers, gums, gelatin; antioxidants; flavor enhancers; acidifiers; colouring agents; sugars; microbial cultures; seasonings; vegetables; spices; nuts, and mixtures thereof. It is particularly preferred that the meat preparation of step (1) contains at least NaCl or mixtures of NaCl with substitutes thereof. The auxiliary ingredients, with the exception of preservatives (e.g. NaNO2 ≦150ppm) are preferably used in the range of 0.01% to 10% (w/w) of the meat paste/meat mass or as permitted by food regulation. Depending on the type and quality of the starting meat raw materials (e.g. protein content, pH), as well as on the amount of added oil (e.g. 0.5-5% w/w of the meat paste/ meat mass), the use of added emulsifiers in step (1) may not be necessary.

For step (2), suitable oils are described under the term “oil”. Preferably, the oil is olive oil. The aqueous medium of step (3) is described under the term “aqueous medium”, above. The temperature of the aqueous medium of step (3) is preferably lower than 25° C., more preferably lower than 15° C. and most preferably lower than 5° C. Preferably, the water is icy water of a temperature between 0.5-2° C., prepared for example by adding ice to tap water. In that case, the water is mainly at a liquid state, in a percentage, preferably in the range of 65% (v/v), more preferably in the range of 75% (v/v) and most preferably in the range of 85% (v/v).

Step (4) comprises the direct admixture, in a simultaneous mode, of oil (2) and of a quantity of an aqueous medium (3), into the meat preparation of step (1) and can include further processing, e.g. by mixing or mixing and chopping, until the added liquids are fully incorporated in the mixture. Step (4) is preferably carried out in a chopping and mixing apparatus or/and in a mixing apparatus, such as a bowl chopper (cutter) or/and an emulsifying apparatus. The term “simultaneous”, as used in the present invention means that oil is added at the same time as a quantity of the aqueous medium is added, or before an added quantity of the aqueous medium is fully incorporated into the meat preparation; or a quantity of the aqueous medium is added before the added oil is fully incorporated into the meat preparation. According to the present invention, the addition of oil occurs simultaneously to the addition of a quantity of the aqueous medium. Other quantities of the aqueous medium may be added into the meat preparation, independently of the oil addition, throughout the process of preparing the meat paste/ meat mass.

In the frame of the present invention, the term “meat paste” refers to finely comminuted meat mass, preferably suited for the production of emulsion-type products, such as frankfurters and parizers. According to the present invention, the term “meat mass” refers to coarsely comminuted meat mass, preferably suited for the production of coarsely comminuted meat-based products, such raw (fresh) country sausages.

An exemplary mixing ratio of oil and aqueous medium is between 1:0.1 to 0.1:1 (w/w), preferably between 1:0.25 to 0.25:1 (w/w), more preferably 1:0.5 to 0.5:1 (w/w). According to a preferred embodiment of the present invention, the oil (2) and the aqueous medium (3) are separately added to the meat preparation and not mixed together before their addition in the meat preparation (1). The process of step (4) is preferably carried out in an appropriate mixing and chopping machine or/and mixing machine, such a bowl chopper (or cutter) or an emulsifying apparatus. According to a preferred aspect of the invention, the simultaneous admixture of (2) and (3) into the mixture of (1), takes place in a multi-step mode. In the latter case, mixing occurs between successive addition steps or preferably during the course of each addition step, as well. According to a further preferred embodiment, no emulsifier and/or stabiliser and/or thickener or gelling agent is added into the meat preparation of step (1) simultaneously to the addition of (2) and (3).

Finally, step (5), of the aforementioned procedure, provides a finely comminuted meat paste or coarsely comminuted meat mass, prepared according to practices known in the art. The procedure under step (5) can include further comminuting or/and mixing of the meat preparation, until the desired homogenisation and/or chopping effect has been obtained. Step (5) may also serve for the addition of additional ingredients, such as pieces of fat tissue and meat pieces, which provide typical characteristics in certain products, such as the addition of fat tissue during the making of a Mortadella product. Step (5) is preferably carried out in a chopping and mixing apparatus or/and mixing apparatus, such as a bowl chopper (cutter) or emulsifying apparatus, in a potential sequence with a grinder, if desired. The addition of auxiliary ingredients during step (5) is possible. Depending on the type and quality of the starting meat raw materials (e.g. protein content, pH), as well as on the amount of added oil (e.g. 0.5-5% w/w of the meat paste/ meat mass), the use of added emulsifiers in step (5) may not be necessary.

The temperature of steps (1), (4) and (5), does not exceed preferably 25° C., more preferably 12° C. and most preferably 8° C.

Thus, according to a preferred embodiment of the invention, the method of the present invention, based on a multi-step addition of oil and in specific on a two-step addition of the oil, with simultaneous addition of water, is intended for the preparation of cooked emulsion-type sausages and comprises the steps of:
(a) Mixing comminuted meat with water and/or ice, NaCl or mixtures of NaCl with replacers thereof, in an appropriate processing machine, e.g. mixing machine or mixing and chopping machine, optionally in the presence of at least one additional auxiliary ingredient;
(b) Adding a first portion of oil and a quantity of water into the mixture of step (a) and further mixing the resulting mixture until oil and added water have been fully incorporated, whereof the first portion of oil preferably represents 60-80% (w/w) of the overall amount of oil to be added;
(c) Adding a second portion of oil and a quantity of water to the mixture of step (b) and further mixing the resulting mixture until oil and added water have been fully incorporated, whereof the second portion of oil preferably represents 40-20% (w/w) of the overall amount of the oil to be added;
(d) Continuing processing until a meat paste is obtained, optionally adding at least one auxiliary ingredient;
(e) Encasing the resulting mixture of step (d) in stuffing materials or in canning materials;
(f) Subjecting the stuffed or canned products from step (e) to a heat treatment;

Steps (a) to (d) are preferably conducted in a mixing or mixing and chopping apparatus, such as a bowl chopper (cutter) and/or emulsifying apparatus or microcutter. It is preferred that the temperature of the meat-based mixture in steps (a) to (d) does not exceed 25° C., more preferably 12° C. and most preferably 8° C.

In step (a) of the aforementioned procedure, a finely or coarsely comminuted meat preparation is prepared using preferably lean meat. The term “lean meat”, used in this context, refers to meat having a fat content of up to 10% (w/w), preferably of up to 8% (w/w), more preferably of up to 5% (w/w) and most preferably of up to 3% (w/w). By the term “meat”, any kind of edible meat is included, preferably beef meat, veal meat, pork meat, poultry meat (such as chicken meat, turkey meat, canard meat, goose meat) or fish meat, such as codfish, salmon and tuna. Preferably, the meat used according to the method of the invention is selected from beef meat, veal meat, pork meat, poultry meat (such as chicken meat, turkey meat, canard meat, goose meat) or mixtures thereof. The term “auxiliary ingredients”, as used in this context, comprises any ingredient conventionally used for the production of cooked sausages, from the list above. The auxiliary ingredients that may be added during step (a) to (d) are preferably in the ranges as recommended from supplier specifications or according to taste preferences or according to food regulation, typically in the range of 0.01% (w/w) to 10% (w/w) of the meat paste (the exception being the nitrite salts). The amount of water/ice added during step (a) is preferably in the range of 10-50% (w/w) of the total amount of added water in product formulation. Step (a) is conducted according to conventional procedures known in the art for the production of finely or coarsely comminuted meat preparation, suited for cooked emulsion-type sausages. An exemplary method for the production of a finely or coarsely comminuted meat preparation is the following: Lean meat without visible fat is comminuted in the presence of table salt (NaCl) and nitrite salts, water or ice flakes, inside the bowl of a cutter. The process of mixing and/or mixing and chopping continues up to the full homogenization of the mixture.

Step (b) comprises the simultaneous addition of a first portion of oil, and a quantity of water, followed by further processing, e.g. mixing or mixing and chopping. An exemplary ratio of oil and water amounts for each addition step is between 1:0.1 to 0.1:1 (w/w), preferably between 1:0.25 to 0.25:1 (w/w), more preferably 1:0.5 to 0.5:1 (w/w). An amount of oil up to 20% (w/w), preferably up to 15% (w/w) and more preferably up to 10% (w/w), based on the total meat paste formulation, may be added in this step. An exemplary method for the preparation of the mixture of step (b) is the following: A first quantity of oil and a quantity of water are admixed simultaneously into the mixture of step (a), within the bowl of a bowl chopper (cutter). The combination of water and oil, prior to admixing into the mixture of step (a) is possible, but not preferable. Processing of the mixture continues, e.g. by mixing or mixing and chopping, until the amounts of oil and water are fully incorporated therein. Similarly, step (c) comprises the simultaneous addition of a second portion of oil, and a quantity of water, followed by further processing, e.g. mixing or mixing and chopping. An amount of oil up to 15% (w/w), preferably up to 10% (w/w) and more preferably up to 5% (w/w), based on the total meat paste formulation, may be added in this step. Processing of the resulting meat mixture continues, e.g. by mixing or mixing and chopping, until oil and water have been fully incorporated therein. The total quantity of the added aqueous medium, i.e. water in the meat paste, does not exceed preferably the 40% (w/w), more preferably the 30% (w/w) and even more preferably the 25% (w/w). The addition of auxiliary ingredients during the course of steps (b) and (c) is possible, but not necessary. According to a further preferred embodiment, no emulsifier and/or stabiliser and/or thickener or gelling agent is added into the meat preparation of step (a) simultaneously to the addition of oil and aqueous medium. Finally, step (d) comprises further processing until the desired meat paste is obtained, e.g. by mixing or/and chopping, to achieve a desired chopping effect.

Then, in step (e) the resulting meat paste, is filled in suitable containers, e.g. natural or artificial stuffing materials or in canning materials and is subjected to a heat treatment in step (f). Steps (e) to (f), of the abovementioned procedure, are conducted according to conventional procedures known in the art for the preparation of cooked sausages.

The present invention will now be further illustrated by the following example.

### EXAMPLE

### Example 1

### Preparation of Olive Oil-Containing Cooked Sausages, Using Different Direct Admixture Protocols

Example 1, shows a comparison of stability (capacity to stably retain added liquids) of olive oil-containing cooked sausages, wherein olive oil has been incorporated following a different direct oil addition protocol. The common feature amongst the different addition protocol is that olive oil, has been admixed directly in the meat preparation, without pre-emulsification, in its natural form. Three different batches of cooked sausages were made, all having the same product formulation, as shown in Table 1. Table 2 provides the different oil addition protocols employed, indicating the stages for olive oil insertion in the meat preparation, during the preparation of the meat-paste.

TABLE 1

| Ingredients | Concentration (w/w %) |
|---|---|
| Ham 5D | 50.00 |
| Water | 32.56 |
| Nitrite Salt (18% NO2) | 0.08 |
| Table Salt | 1.80 |
| Phosphates | 0.50 |
| Sodium Erythorbate | 0.056 |
| Extra Virgin Olive Oil | 15.00 |

TABLE 2

| MIN | Test Batch 1 | Test Batch 2 | Test Batch 3 |
|---|---|---|---|
| 0 | Start of Processing | Start of Processing | Start of Processing |
| | T. Salt, N. Salt | T. Salt, N. Salt | T. Salt, N. Salt |
| 0.5 | H2O | H2O | H2O |
| 1.5 | Phosphates | Phosphates | Phosphates |
| 4.5 | | Olive Oil | Olive Oil + H2O |
| 6.0 | Olive oil | Olive oil | Olive Oil + H2O |
| 7.0 | Sodium | Sodium | Sodium |
| | Erythorbate | Erythorbate | Erythorbate |
| 9.0 | End of Processing | End of Processing | End of Processing |

Meat paste preparation: Partially thawed lean meat 5D (−5.5° C.) was grinded and placed in the bowl of a bowl chopper, for further processing. Comminution commenced in the presence of Table Salt, Nitrite Salt and water. For batch 1 and 2, the whole amount of water to be added was introduced into the meat preparation during this initial mixing stage. In the case of test batch 3, a quantity of water equal to 10% wt, based on the product formulation, was added in the initial mixing stage. The mixture of phosphates was then added and mixing continued, by gradually increasing the knife cutting speed to 4000rpm. The oil was added directly into the meat preparation during processing, at a different stage for each batch, as shown in Table 2. For test batches 2 & 3, the quantity of oil was subdivided into two portions of 7.5% wt each, based on the meat paste formulation. For test batch 3, the remaining quantity of water to be added, was divided into two portions of 11.28% wt. based on the meat paste formulation, which were added simultaneously with each portion of olive oil, as described in the present patent. The total mixing time for all batches was 9 min and the temperature range maintained during the course of processing in the cutter was between −1 to 8° C. The resulting mixtures were stuffed into plastic casings to obtain sausage blocks (3.5 kgr each), and were pasteurised, according to known practices in the art. Following thermal processing, the test samples were kept at 4° C. until use.

Freeze-Thaw Test

On the day of analysis, three samples of each test batch were analysed by the freeze & thaw test for their capacity to stably retain the added oil and water. For this purpose, 100 gr of the each sample/item, taken from different sampling points, (Right, Center, Left) were cut in cubes (0,5×0,5×0,5 cm) and placed in a freezer, at a temperature of −38° C., for 24 hours. The samples were then left at room temperature (20° C.) onto a pre-weighed absorbing paper. The liquid losses (gr) were measured for each test batch (n=3) and are as shown in Table 3.

TABLE 3
Liquid losses (gr)/100 gr of sample

| | | |
|---|---|---|
| Samples from test batch 1 | 12.18 | (stdev = 0.35) |
| Samples from test batch 2 | 10.68 | (stdev = 0.24) |
| Samples from test batch 3 | 8.58 | (stdev = 0.20) |

As shown by the results presented above, the samples of the test batch 3 presented less exudation of liquids.

1. A process for preparing oil-containing meat-based products, comprising adding simultaneously oil and an aqueous medium to a meat preparation.

2. The process of claim 1, wherein the oil has not been pre-emulsified before the addition.

3. The process of claim 1, wherein the simultaneous addition of oil and aqueous medium is carried out in a multi-step mode.

4. The process of claim 1, wherein an oil selected from olive oil, palm oil, soybean oil, canola oil, pumpkin seed oil, corn oil, rape oil, sunflower oil, safflower oil, peanut oil, walnut oil, wheat germ oil, grape seed oil, sesame oil, argan oil, rice bran oil, and mixtures thereof, is used.

5. The process of claim 1, wherein the aqueous medium is selected from water, an aqueous solution or aqueous dispersion.

6. The process of claim 1, wherein the aqueous medium does not contain an emulsifier.

7. The process of claim 1, wherein the aqueous medium does not contain a gelling agent.

8. The process of claim 1, wherein the oil and the aqueous medium are separately added to the meat preparation and not mixed together before the addition.

9. The process of claim 1, wherein no emulsifier is added during the simultaneous addition of the oil and aqueous medium.

10. The process of claim 1, wherein no gelling agent is added during the simultaneous addition of the oil and aqueous medium.

11. The process of claim 1, wherein the oil and aqueous medium are added to comminuted or minced meat preparation.

12. The process of claim 1, wherein the oil is added at the same time as a quantity of the aqueous medium is added, or before an added quantity of the aqueous medium is fully incorporated into the meat preparation; or a quantity of the aqueous medium is added before the added oil is fully incorporated into the meat preparation.

13. The process of claim 1, wherein the oil and the aqueous medium are added in a ratio of 1:0.1 to 0.1:1 (w/w).

14. The process of claim 1, wherein the meat-based products are finely and/or coarsely comminuted or minced meat-based products.

15. The process of claim 1, wherein the process comprises preparing a meat preparation by comminuting or mincing meat pieces, adding sodium chloride or mixtures of sodium chloride with substitutes thereof, and optionally adding at least one ingredient selected from antioxidants, stabilizers, emulsifiers, thickeners or gelling agents, processing aids, colouring agents, sugars, vegetables, microbial cultures, preservatives, flavor enhancers, acidifiers, seasonings, spices, nuts and mixtures thereof; adding a first portion of oil and simultaneously adding a portion of aqueous medium and mixing until the oil and aqueous medium have been incorporated, adding a second portion of oil and simultaneously adding a portion of aqueous medium and mixing until the oil and aqueous medium have been incorporated; and further processing to obtain the meat-based product.

16. Meat-based products obtainable by the process according to claim 1.

17. The process of claim 1, wherein the simultaneous addition of oil and aqueous medium is carried out in a two-step mode.

18. The process of claim 1, wherein the oil is olive oil.

19. The process of claim 1, wherein the oil and the aqueous medium are added in a ratio of 1:0.25 to 0.25:1 (w/w).

20. The process of claim 1, wherein the meat-based products are cooked sausages, raw sausages, minced meat-based products or spreadable products.
